(19) United States
(12) Patent Application Publication
(10) Pub. No.: US 2025/0139413 A1
(43) Pub. Date: May 1, 2025

(54) PERSONALIZED MACHINE LEARNING CONVERSATION SYSTEM

(71) Applicant: Airbnb, Inc., San Francisco, CA (US)

(72) Inventors: Yuanpei Cao, Norman, OK (US); Wei Ji, Beijing (CN); Xiang Lan, Beijing (CN); Lianghao Li, Redwood City, CA (US); Zhu Xiong, Mercer Island, WA (US); Can Yang, Beijing (CN); Shuohao Zhang, San Jose, CA (US); Ying Zhang, Palo Alto, CA (US); Yang Zhao, Beijing (CN); Yuyang Zhou, Seattle, WA (US)

(21) Appl. No.: 18/527,946

(22) Filed: Dec. 4, 2023

Related U.S. Application Data
(63) Continuation of application No. PCT/CN2023/127630, filed on Oct. 30, 2023.

(51) Int. Cl. G06N 3/0455; G06N 3/0475; G06N 3/094

(52) U.S. Cl. CPC G06N 3/0455; G06N 3/0475; G06N 3/094

(57) ABSTRACT

A system is described for allowing a user to communicate with an agent of a listing network platform. The system receives, by a network site, a user interaction in a communication session with an agent of a listing network platform. The system analyzes, by a first machine learning model, a profile associated with the user on the listing network platform to predict a subset of information that is relevant to the user interaction with the communication session. The system combines the subset of information into a prompt and processes the prompt by a generative machine learning model to generate a message that responds to the user interaction. The system, in response to receiving the user interaction, presents the message by the agent of the listing network platform to the user in a user interface of the listing network platform.

### PRIORITY

This application claims the benefit of priority from International Application No. PCT/CN2023/127630, filed Oct. 30, 2023, which is incorporated by reference herein in its entirety.

### TECHNICAL FIELD

The present disclosure generally relates to special-purpose machines that manage data processing and improvements to such variants, and to the technologies by which such special-purpose machines become improved compared to other special-purpose machines for generating visual interfaces.

### BACKGROUND

Network site users can create content for viewing and interaction by other network site users (e.g., booking, registering, subscribing, viewing of listings). The posted content can be updated, created, or deleted, and it can be computationally challenging for a network site to return valid search results to network site users searching for content (e.g., listings for reservations) with specified parameters (e.g., dates, categories, prices, quantity). For example, if there are a large number of users posting and updating content and also a large number of users submitting complex searches for the posted content, any delay in computation due to query complexity may cause inaccurate results to be returned and cause large computational resource consumption (e.g., processing, memory, network overhead).

### BRIEF DESCRIPTION OF THE DRAWINGS

Various ones of the appended drawings merely illustrate examples of the present disclosure and should not be considered as limiting its scope.

FIG. 1 is a block diagram illustrating a communication session system implemented in a networked environment, according to some examples.

FIG. 2 shows an example of functional engines of a communication session system, according to some examples.

FIG. 3 shows a listings network site user interface generated by the listing network platform and communication session system, according to some examples.

FIG. 4 shows a prompt framework used by the communication session system, according to some examples.

FIGS. 5 and 6 show example user interfaces for the communication session system, according to some examples.

FIG. 7 shows a flow diagram of various processes and methods for operating the communication session system, according to some examples.

FIG. 8 is a block diagram illustrating the architecture of software used to implement the disclosed system, according to some examples.

FIG. 9 shows a machine as an example computer system with instructions to cause the machine to implement the disclosed system, according to some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

As discussed above, it can be difficult to return up-to-date results for complex queries for content posted on a network site. In addition, navigating the vast array of content available on the network site can be very complex and time consuming. Such navigation can entail browsing multiple pages of information to find a suitable result or action. Although in the following discussion the example posted content are accommodations listings (e.g., listings for reservations) posted on a network site for searching and interacting with other end users, other types of network site content posted by end users and searched for by other end users can likewise be implemented in the user interface processes and methods, such as transportation, experiences, and/or events.

Generally, a listing platform can be searched for result listings that are available for a specified date range, price range, and/or other attributes (amenities, cancelation policy, etc.), which can be specified in a given query (e.g., text field, drop-down menu, checkbox filters). To search and browse the listing platform, users can access the listing platform on a particular user interface channel, such as by phone or through an application associated with the listing platform. Sometimes, users encounter issues or difficulties finding a resolution to an issue or finding the appropriate resources to perform an action. For example, users can encounter a problem with a reservation that needs to be modified or canceled. Users typically contact a live human agent to address these issues. However, waiting for a live human agent to address issues or help users is very time consuming and wastes a great deal of resources as users need to spend time on the phone waiting for an agent to respond. This wastes bandwidth and battery of the device. Certain systems allow users to chat with virtual agents or bots to find resolutions to the issues. However, these agents are not sophisticated enough to be able to provide resolution to most issues as they generally are programmed to provide static responses to queries that include certain keywords. As such, even accessing such virtual agents can waste time and frustrate users and the users may still have to contact a live human agent to resolve issues. Such repetitive and manual processes are incredibly time consuming and can be very frustrating to end users. This can result in missed opportunities and wasted computational resources.

To address these technical problems, the disclosed techniques provide a network site that allows a user to interact in a communication session with an agent (e.g., a smart virtual agent) on the listing network site in real time. Namely, the network site can receive a user interaction in a communication session with an agent of a listing network platform. The network site analyzes, by a first machine learning (ML) model, a profile associated with the user on the listing network platform to predict a subset of information that is relevant to the user interaction with the communication session. The network site combines the subset of information into a prompt and processes the prompt by a generative ML model to generate a message that responds to the user interaction. The network site, in response to receiving the user interaction, presents the message by the agent of the listing network platform to the user in a user interface of the listing network platform. This, in effect, reduces the amount of computational resources needed to be dedicated and consumed by a given user interface channel (e.g., associated with a human agent), which frees up such resources for other tasks and satisfying other search requests.

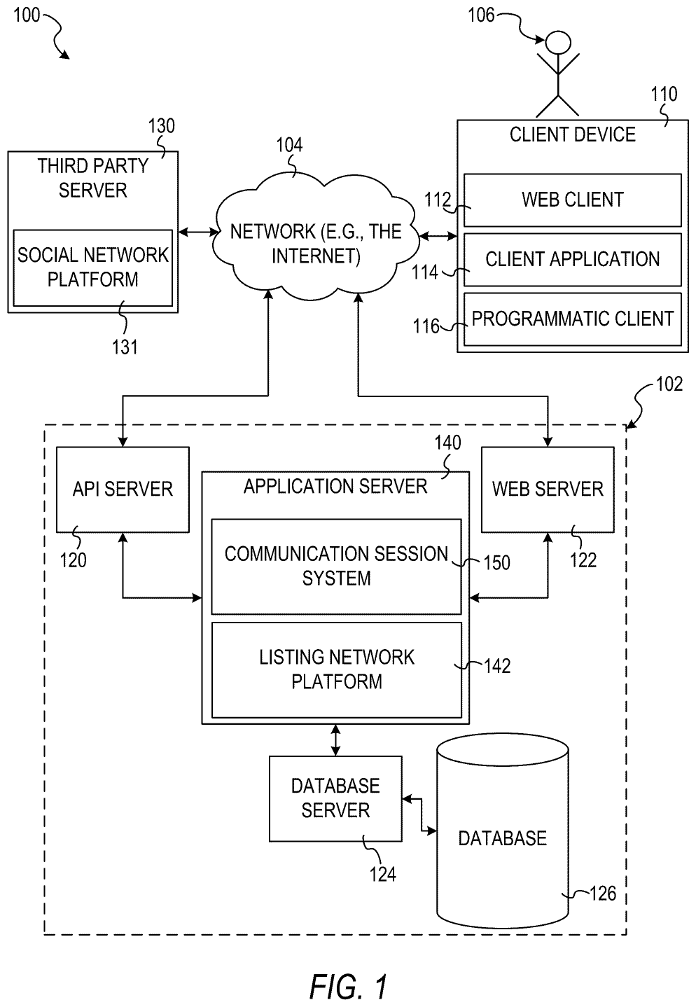

With reference to FIG. 1, an example of a high-level client-server-based network architecture 100 is shown. A networked system 102, in the example form of a network-based listing services system, provides server-side functionality via a network 104 (e.g., the Internet or wide area network (WAN)) to one or more client devices 110. In some implementations, a user (e.g., user 106) interacts with the networked system 102 and/or a third-party server 130 that hosts a social network platform 131 using the client device 110.

FIG. 1 illustrates, for example, a web client 112 (e.g., a browser), a client application(s) 114, and a programmatic client 116 executing on the client device 110. The client device 110 includes the web client 112, the client application(s) 114, and/or the programmatic client 116 alone, together, or in any suitable combination. Although FIG. 1 shows one client device 110, in other implementations, the network architecture 100 includes multiple client devices.

In various implementations, the client device 110 can include a computing device that includes at least a display and communication capabilities that provide access to the networked system 102 via the network 104. The client device 110 comprises, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronics, game console, set-top box (STB), network personal computer (PC), mini-computer, and so forth. In an example, the client device 110 comprises one or more of a touch screen, accelerometer, gyroscope, biometric sensor, camera, microphone, Global Positioning System (GPS) device, and the like.

The client device 110 can implement a first user interaction channel (e.g., an interaction voice response (IVR) system or telephone communication channel) and also a second user interaction channel (e.g., a graphical user interface (GUI) of a client application 114) that communicates over a network, such as the Internet with a remote server. While the disclosed techniques generally refer to telephone or voice-only based communication channels as the “first user interaction channel” and a client application 114 GUI-based communications through a network as the “second user interaction channel,” in some cases the second user interaction channel can perform the functions and take the place of the first user interaction channel and the first user interaction channel can perform the functions and take the place of the second user interaction channel. The first user interaction channel can correspond to an IVR service of a communication session system 150.

The client device 110 communicates with the network 104 via a wired or wireless connection. For example, one or more portions of the network 104 comprises an ad hoc network, an intranet, an extranet, a Virtual Private Network (VPN), a Local Area Network (LAN), a wireless LAN (WLAN), a WAN, a wireless WAN (WWAN), a Metropolitan Area Network (MAN), a portion of the Internet, a portion of the Public Switched Telephone Network (PSTN), a cellular telephone network, a wireless network, a Wireless Fidelity (WI-FI®) network, a Worldwide Interoperability for Microwave Access (WiMax) network, another type of network, or any suitable combination thereof. In communicating with the network 104 through the first user interaction channel, the client device 110 may only send audio or voice data to the network 104. In communicating with the network 104 through the second user interaction channel, the client device 110 may send data representing selections on a GUI, image content, and/or audio or voice data to the network 104.

In some examples, the client device 110 includes one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, e-commerce site apps (also referred to as “marketplace apps”), and reservation applications for temporary stays or experiences at hotels, motels, or residences managed by other end users (e.g., a posting end user who owns a home and rents out the entire home or private room). In some implementations, the client application(s) 114 include various components operable to present information to the user and communicate with the networked system 102. In some examples, if the e-commerce site application is included in the client device 110, then this application is configured to locally provide the user interface and at least some of the functionalities with the application configured to communicate with the networked system 102, on an as-needed basis, for data or processing capabilities not locally available (e.g., access to a database of items available for sale, to authenticate a user, to verify a method of payment). Conversely, if the e-commerce site application is not included in the client device 110, the client device 110 can use its web browser to access the e-commerce site (or a variant thereof) hosted on the networked system 102.

The web client 112 accesses the various systems of the networked system 102 via the web interface supported by a web server 122. Similarly, the programmatic client 116 and client application(s) 114 accesses the various services and functions provided by the networked system 102 via the programmatic interface provided by an Application Program Interface (API) server 120.

Users (e.g., the user 106) can include a person, a machine, or other means of interacting with the client device 110. In some examples, the user 106 is not part of the network architecture 100, but interacts with the network architecture 100 via the client device 110 or another means. For instance, the user 106 provides input (e.g., touch screen input or alphanumeric input) to the client device 110 and the input is communicated to the networked system 102 via the network 104 by way of the second user interaction channel. In this instance, the networked system 102, in response to receiving the input from the user 106, communicates information to the client device 110 via the network 104 to be presented to the user 106. In this way, the user 106 can interact with the networked system 102 using the client device 110. As another example, the user 106 provides input (e.g., speech input) to the client device 110 and the input is communicated to the networked system 102 via the network 104 in the form of audio packets or audio data by way of the first user interaction channel.

The API server 120 and the web server 122 are coupled to, and provide programmatic and web interfaces respectively to, one or more application server(s) 140. The application server(s) 140 may host a listing network platform 142 and a communication session system 150, each of which includes one or more modules or applications and each of which can be embodied as hardware, software, firmware, or any combination thereof. The application server(s) 140 are, in turn, shown to be coupled to one or more database server(s) 124 that facilitate access to one or more information storage repositories or database(s) 126. In an example, the database(s) 126 are storage devices that store information to be posted (e.g., inventory, image data, catalog data) to the listing network platform 142. The database(s) 126 also stores digital goods information, in accordance with some examples.

The listing network platform 142 provides a number of publication functions and listing services to the users who access the networked system 102. While the listing network platform 142 is shown in FIG. 1 to form part of the networked system 102, it will be appreciated that, in alternative examples, the listing network platform 142 may form part of a web service that is separate and distinct from the networked system 102. In some implementations, the communication session system 150 provides functionality to provide a smart or intelligent virtual agent that is controlled by multiple large language models (LLMs) or multiple generative ML models to provide intelligent and automated responses to user queries or requests, as discussed in further detail below. In some cases, the communication session system 150 uses the intelligent virtual agent to only provide a greeting message (e.g., a first initial message presented to a user upon receiving a request from the user to engage in the communication session). Then, the communication session system 150 uses a standard chatbot and default responses to address further inquiries. In some cases, the communication session system 150 continues to use the multiple LLMs or multiple generative ML models to respond continuously to subsequent user queries or requests.

While the client-server-based network architecture 100 shown in FIG. 1 employs a client-server architecture, the disclosed techniques are not limited to such an architecture, and can equally be implemented in a distributed, or peer-to-peer, architecture system, for example. The various systems of the applications server(s) 140 (e.g., the listing network platform 142 and communication session system 150) may also be implemented as standalone software programs, which do not necessarily have networking capabilities.

The listing network platform 142 can be hosted on dedicated or shared server machines that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components access one or more database(s) 126 via the database server(s) 124. The listing network platform 142 provides a number of publishing and listing mechanisms whereby a seller (also referred to as a “first user,” posting user, host) may list (or publish information concerning) goods or services for sale or barter, a buyer (also referred to as a “second user,” searching user, guest) can express interest in or indicate a desire to purchase or barter such goods or services, and a transaction (such as a trade) may be completed pertaining to the goods or services.

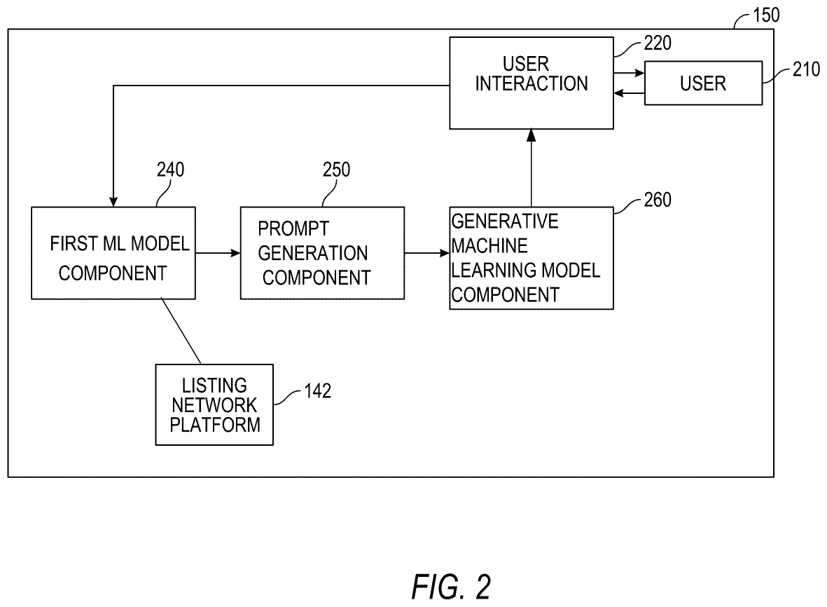

FIG. 2 shows example functional engines of the communication session system 150, according to some examples. As illustrated, the communication session system 150 includes a user interaction channel 220 that is used to receive and provide inputs/outputs to a user 210, a first ML model component 240, a prompt generation component 250, and a generative ML model component 260. In some examples, the user 210 may desire to perform some action with the listing network platform 142 or request to initiate a communication session with the listing network platform 142 to assist with performing the action. For example, the user may desire to search for a listing for a reservation, modify one or more reservations held by the listing network platform 142, list a reservation on the listing network platform 142, communicate with a host of a listing on the listing network platform 142, request a refund for a reservation or cancel the reservation on the listing network platform 142, pay for services on the listing network platform 142, and/or to perform any other available function on the listing network platform 142. The listing network platform 142 can maintain a profile for the user 210 that stores various personal information about the user including historical interactions the user had with the listing network platform 142 and behaviors of the user on the listing network platform 142. The first ML model component 240 and the generative ML model component 260 can use the profile for the user 210 to generate responses intelligently that are included in messages presented by an agent to the user via the user interaction channel 220.

In some cases, the user 210 may initiate contact with the listing network platform 142 through any number of user interaction channels, such as the user interaction channel 220 and/or a second user interaction channel. For example, the user 210 can establish the user interaction channel 220 with the listing network platform 142 by placing a telephone call using the client device 110 to a service phone number associated with the listing network platform 142. In response to receiving the telephone call, the listing network platform 142 can search a database that associates a telephone number of the client device 110 with an account of the user 210 on the listing network platform 142. Specifically, the listing network platform 142 can receive the phone call and route the phone number of the client device 110 to a session management component. The session management component can search the database to locate an account associated with the phone number on the listing network platform 142.

Once the session management component locates the account, the session management component can retrieve a profile for the user 210 on the listing network platform 142 and provide access to the profile to the first ML model component 240 and/or the generative ML model component 260. Then, the first ML model component 240 and/or the generative ML model component 260 together or separately can generate an intelligent message for presentation through an audible prompt on the client device 110 via the user interaction channel 220. The audible prompt can include a personalized greeting that includes various information that has been determined to be relevant from the user profile and may provide instructions on how to perform certain actions to address predicted issues from the user profile.

The user interaction channel 220 can receive verbal or audible input from the user 210 via the user interaction channel 220 in response to presenting the audible prompt to the user 210. The first ML model component 240 can convert the verbal input to text and then communicate with the generative ML model component 260 to generate an additional message that responds to the verbal or audible input received from the user 210.

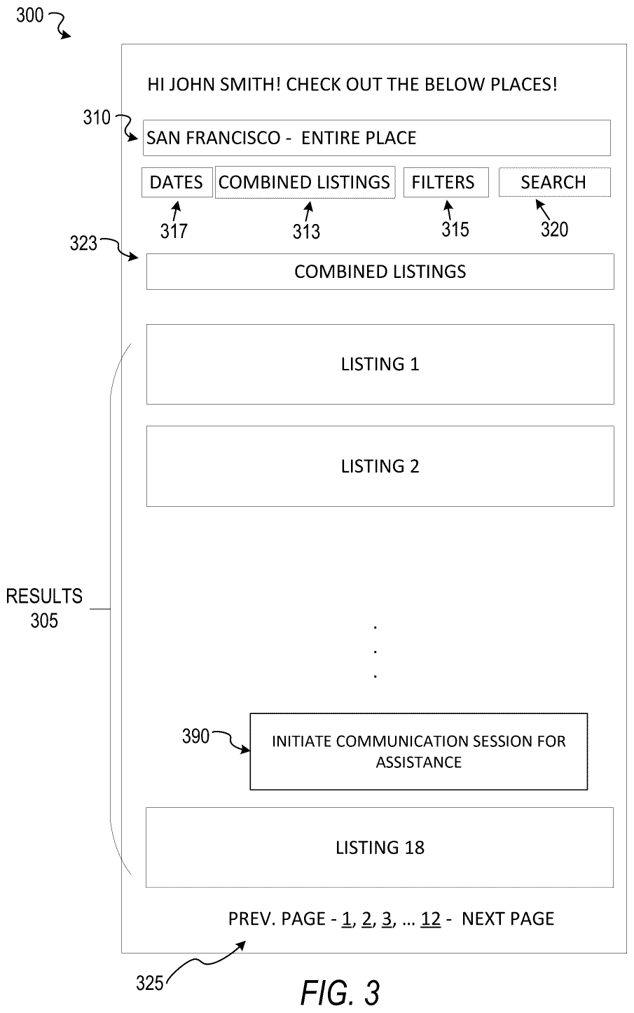

In some examples, the communication session is initially started with the programmatic client 116, and the messages provided by the generative ML model component 260 are presented through the user interaction channel 220 on the programmatic client 116. For example, FIG. 3 shows a listings network site user interface 300 (e.g., mobile application user interface, web browser user interface) generated by the listing network platform 142 and communication session system 150, according to some examples. The user interface 300 can be presented by the programmatic client 116 implemented on the client device 110. As illustrated, the user interface 300 includes a search field 310, a filters menu element 315 (e.g., place type, amenities), and a search button 320. The user enters a listings query into the search field 310, such as a search for temporary housing in San Francisco, and a category limitation from the filters menu element 315 of “Entire Place” (e.g., the user seeks to rent the entire residence for said dates, as opposed to renting a private room in another person's residence). The user can customize the query directly using terms input into the search field 310 or filters listed via selection of the filters menu element 315. Further, the user can select dates using a dates drop-down element 317 to select a specific date range for the temporary stay. For example, the user can select the dates drop-down element 317 and a pop-up calendar (not depicted in FIG. 3) to specify the stay in San Francisco is to be specifically from Jul. 16, 2021 to Jul. 18, 2021.

Upon submitting the query (e.g., via selection of the search button 320, or automatically upon selecting a combined listings element 313 (split stays option) or dates drop-down element 317, a communication is sent from the programmatic client 116. The communication session system 150 generates an output that includes a results display of the listings matching the query and transmits the output via the programmatic client 116. The results are then displayed in the listings results area 305. The user can then select the listings or navigate to additional pages via page navigational elements 325. In some examples, the user interface 300 includes a set of combined listings 323 together with individual listings displayed in the results area 305. The combined listings 323 can be positioned within the display in a dedicated area, on top of the individual listings, between two individual listings, and/or underneath the individual listings. In some examples, the combined listings 323 are provided in response to receiving input that selects the combined listings element 313. In some examples, the combined listings 323 are presented automatically without receiving input that selects the combined listings element 313.

In some examples, the combined listings 323 are displayed in different slots or portions of the display relative to other individual listings on the basis of the type of client device being used to access the system. For example, on a mobile device, the combined listings 323 can be placed in slots 3, 6, 9, and 12 on the first page, and on a desktop computer, the same combined listings 323 may be presented in slots 5, 9, 14 and 20 for better visual balance. As referred to herein, the term “slots” means an area of a display in which a category is presented. In some cases, the combined listings 323 are excluded from being presented for last minute stays, such as if the travel dates are within 48 hours of check in or starting the trip. In some examples, the combined listings 323 include individual listings of destinations or stays that are at least two hours driving distance apart but no more than 10 hours driving distance apart. In some examples, the combined listings 323 excludes repeating pairs of the same individual listings. In some examples, the combined listings 323 relate to pairs of individual listings from different neighborhoods and locations. In such cases, neighborhoods and listings can be repeated across pairs of combined listings 323.

The user interface 300 includes an option 390 to initiate a communication session for assistance. In response to receiving selection of the option 390, the programmatic client 116 transmits data to the communication session system 150 requesting that a virtual agent respond to requests from the user. The communication session system 150, in response to receiving the indication that the option 390 was selected, identifies a profile associated with the account for which the user interface 300 is presented. The communication session system 150 presents a greeting message that is unique and tailored to the user. Namely, the greeting message presented as a first message in response to receiving input that selects the option 390 can be generated by the combination of the first ML model component 240 and generative ML model component 260.

Referring back to FIG. 2, the first ML model component 240 can implement a first LLM or any other suitable artificial neural network or convolutional neural network. The first LLM can receive a prompt that includes instructions for retrieving or identifying relevant portions of a user profile that correspond to an issue associated with a user. In some cases, the prompt can include a time period, such as a prior two-week period. The first LLM can process the profile and only focus on activity that occurred within the specified time period.

The first LLM can be trained on massive text datasets, often containing billions of words. The goal of this training is to teach the first LLM the statistical relationships between words and language concepts found in the texts. The first LLM can include neural networks, consisting of artificial neurons arranged in layers. Each neuron assigns weights to input words to predict the next word in a sequence. The training process tunes these weights through an algorithm called backpropagation and gradient descent. With enough training examples, the first LLM can learn nuanced patterns in language and generate coherent, human-like text.

During training, the first LLM is shown text excerpts (e.g., from profiles of various users), asked to predict the next word, and then corrected on its guess. Over many iterations across the training dataset, prediction errors are progressively reduced as the first LLM adjusts its internal weights. Once trained, the first LLM can generate text by being given a prompt and predicting the most statistically likely next words (e.g., the words from a profile that match the prompt indicating a request to retrieve relevant information from the profile). The training process allows the first LLM to develop a substantial understanding of language structure and semantics. The second LLM, discussed below, can be implemented in the same manner but over a different collection of text excerpts (e.g., greeting messages).

In some examples, the communication session system 150 can retrieve a profile for the user and obtain information or activity that is associated with timestamps that are less than or equal to the prior time period. For example, the communication session system 150 can retrieve activity that occurred within two weeks prior to a current date. The communication session system 150 can provide that portion of the profile together with the prompt to the first ML model component 240. The prompt can also include a restriction on the quantity of information that is retrieved by the first ML model component 240 from the profile, such as a request to only list the top five relevant activities that the user performed on the listing network platform 142. In some cases, the prompt can instruct the first ML model component 240 to prioritize activity representing conversations between the user 210 and a host of a reservation above other activity that is in the profile. In some cases, the prompt can instruct the first ML model component 240 to predict an emotion or state of a user based on the recent activity (activity performed by the user on the listing network platform 142 within a recent time period) stored in the profile.

The first ML model component 240 processes the entire profile or the portion received from the communication session system 150 together with the prompt. The first ML model component 240 can then generate a list of the most relevant activities detected in the profile that match the prompt. In some examples, the first ML model component 240 receives instructions in the prompt to output the information in a particular format, such as a natural language format or according to a format of a prompt that is provided to the generative ML model component 260. For example, the particular format indicate positioning of a user name first, followed by conversation-related activity, followed by a name or destination associated with a reservation, and followed by an emotional state of the user.

The first ML model component 240 provides the output generated based on the profile and the prompt to the prompt generation component 250. The prompt generation component 250 can determine whether the user interaction channel 220 has previously provided messages to the user 210 in the communication session. Namely, the prompt generation component 250 can determine whether a greeting message has been provided already to the user 210 and/or whether any messages have been presented by the virtual agent to the user 210 recently. If the prompt generation component 250 determines that this is the first time the user 210 accesses the communication session within a specified period of time (e.g., in the last three days or last 24 hours), the prompt generation component 250 determines that a greeting message needs to be presented.

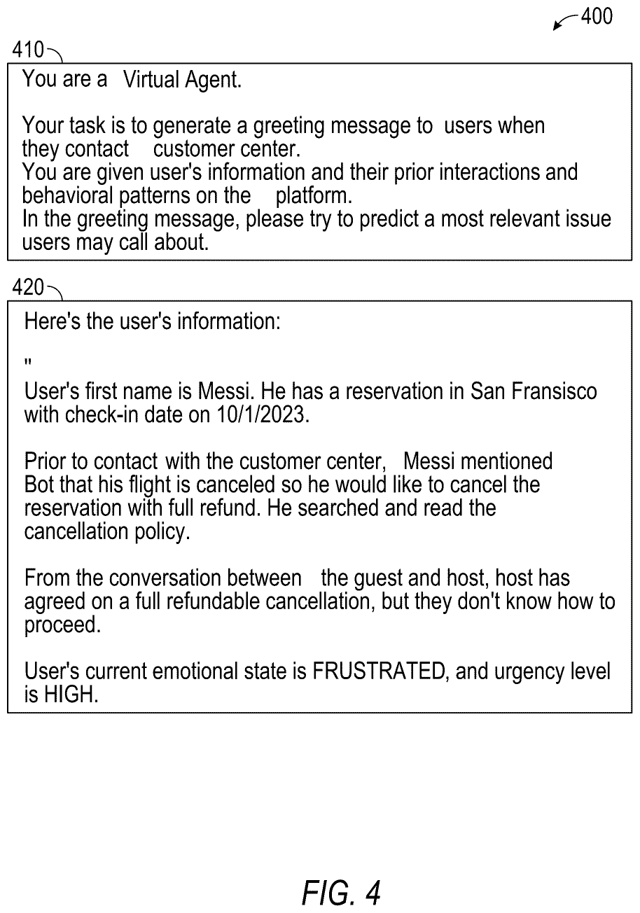

In such cases, the prompt generation component 250 accesses a database of prompts and retrieves a default prompt that is associated with a greeting message. The prompt generation component 250 can augment or modify the retrieved default prompt using the information generated by the first ML model component 240. For example, the prompt generation component 250 can generate the prompt 400, shown in FIG. 4. The prompt 400 can include a first portion 410 with the default prompt retrieved from the database. The prompt 400 has been modified to include a second portion 420 with custom information generated by the first ML model component 240.

The prompt generation component 250 provides the prompt 400 to the generative ML model component 260. The generative ML model component 260 can implement a second LLM, neural network, and/or convolutional neural network. The second LLM can process the prompt 400 and generate a customized, personalized, and intelligent message that is based on the prompt 400. Namely, the second LLM can generate a greeting message that is tailored to the needs of the user as determined and retrieved from the user profile information by the first LLM. The generative ML model component 260 can provide the generated greeting message to the user interaction channel 220 for presentation (e.g., verbally or visually) to the user by the virtual agent.

The second LLM can be trained on massive text datasets, often containing billions of words. The goal of this training is to teach the second LLM the statistical relationships between words and language concepts found in the texts. The second LLM can include neural networks, consisting of artificial neurons arranged in layers. Each neuron assigns weights to input words to predict the next word in a sequence. The training process tunes these weights through an algorithm called backpropagation and gradient descent. With enough training examples, the second LLM can learn nuanced patterns in language and generate coherent, human-like text.

During training, the second LLM is shown text excerpts (e.g., from various types of greeting messages or responses to inquires), asked to predict the next word, and then corrected on its guess. Over many iterations across the training dataset, prediction errors are progressively reduced as the second LLM adjusts its internal weights. Once trained, the second LLM can generate text by being given a prompt and predicting the most statistically likely next words (e.g., the words of a greeting message or response to an inquiry). The training process allows the second LLM to develop a substantial understanding of language structure and semantics.

In some examples, the communication session system 150 receives additional input from the user after the agent presents the greeting message to the user. For example, after initially accessing the communication session and being presented with the greeting message, the user can provide additional input that includes a specific request or inquiry. In response to receiving the additional input, the communication session system 150 processes the additional input by the first ML model component 240 and generative ML model component 260 to generate a new message for presentation by the agent. Specifically, the first ML model component 240 can re-process the profile information together with the additional input that is received and based on the prompt that instructs the first ML model component 240 to identify and retrieve relevant information from the profile.

The first ML model component 240 again retrieves the profile information and prepares a response that includes the retrieved profile information according to a specified format, as discussed above. The response is provided to the prompt generation component 250. The prompt generation component 250 determines that a greeting message has already been presented to the user. In response, the prompt generation component 250 retrieves a new prompt that includes a different default prompt portion. The new prompt that is retrieved can be associated in the database with a specified maximum quantity of messages provided to the user or based on any other criteria. The criteria can include at least one of a time of day, a user interface from which the user interaction is received, a device type being used by the user to perform the user interaction, a quantity of times the user accessed the communication session, a quantity of messages presented to the user by the agent in the communication session, and/or the subset of information retrieved from the profile. As an example, if there have been five or less requests from the user but more than one request, the prompt generation component 250 retrieves the new prompt. The prompt generation component 250 supplements or combines the new prompt with the response received from the first ML model component 240. The prompt generation component 250 then provides the modified new prompt to the generative ML model component 260. The generative ML model component 260 generates a new message and the new message is provided to the user interaction channel 220 for presentation to the user 210 by the virtual agent.

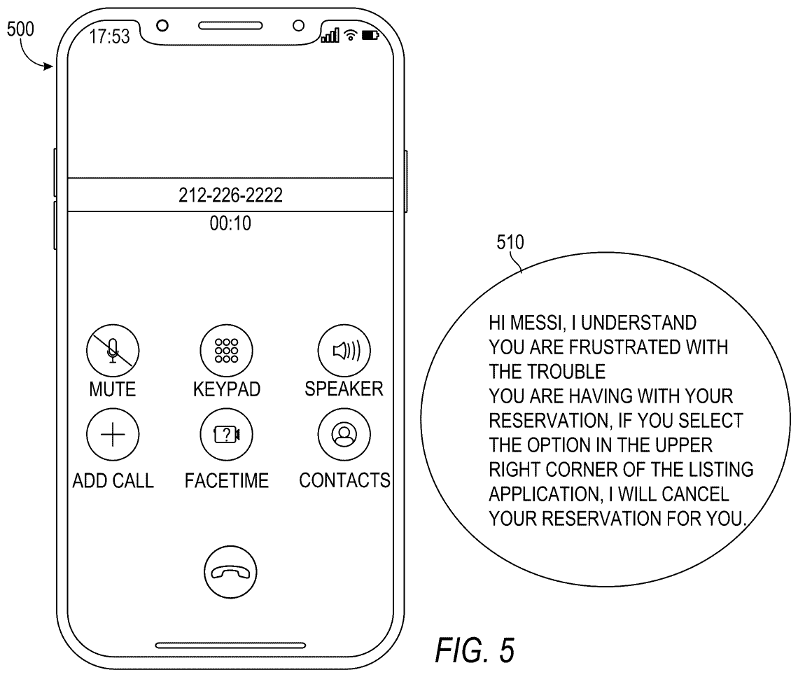

For example, as shown in FIG. 5, the communication session system 150 can receive a phone call 500 from the user. The communication session system 150 can generate a greeting message 510 for presentation to the user verbally on the phone call. The greeting message 510 can be generated based on the first and second LLMs using the profile information associated with the user.

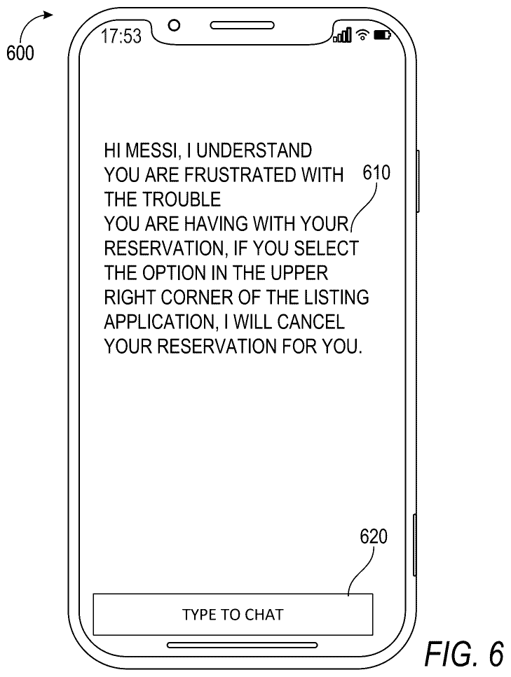

As another example, as shown in FIG. 6, the communication session system 150 can receive a request to access a graphical user interface associated with a communication session with an agent from the user. The communication session system 150 can generate a user interface 600 that includes a greeting message 610 for presentation to the user visually. The greeting message 610 can be generated based on the first and second LLMs using the profile information associated with the user. The user interface 600 can include a text entry region 620. The user can provide additional input or requests based on the messages presented by the virtual agent by typing in text in the text entry region 620. The communication session system 150 processes the additional input or requests and generates new responses to the additional input or requests by processing such additional input or requests by the first ML model component 240 and generative ML model component 260.

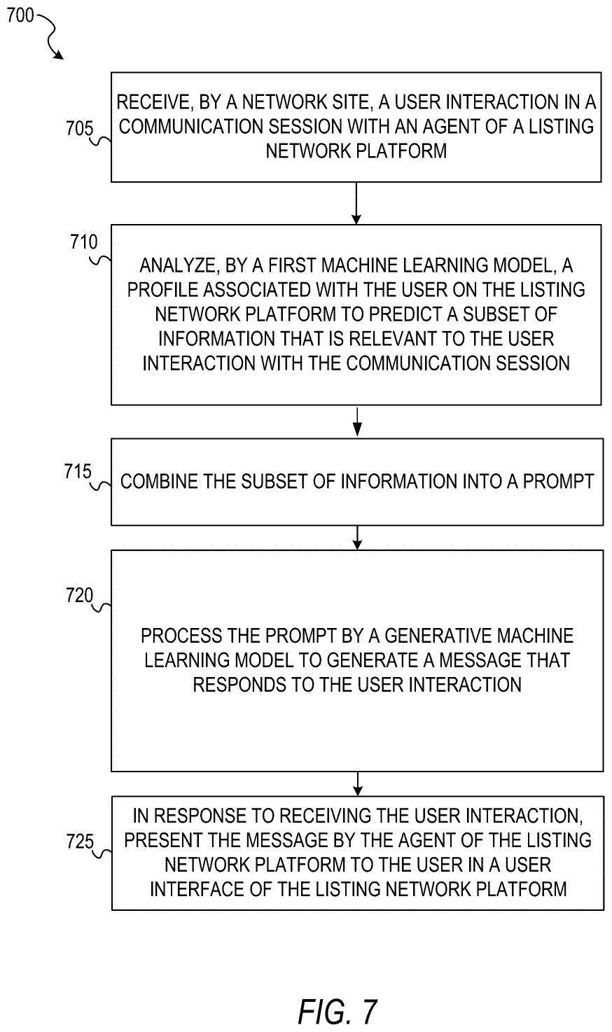

FIG. 7 shows a flow diagram of various processes and methods for operating the communication session system, according to some examples.

At operation 705, the communication session system 150 receives, by a network site, a user interaction in a communication session with an agent of a listing network platform, as discussed above.

At operation 710, the communication session system 150 analyzes, by a first ML model, a profile associated with the user on the listing network platform to predict a subset of information that is relevant to the user interaction with the communication session, as discussed above.

At operation 715, the communication session system 150 combines the subset of information into a prompt, as discussed above.

At operation 720, the communication session system 150 processes the prompt by a generative machine learning model to generate a message that responds to the user interaction, as discussed above.

At operation 725, the communication session system 150, in response to receiving the user interaction, presents the message by the agent of the listing network platform to the user in a user interface of the listing network platform, as discussed above.

In some examples, the agent includes a virtual agent, the first ML model includes a first LLM, and the generative ML model includes a second LLM. In some examples, the communication session includes an IVR communication session. In some examples, the communication session includes an online chat communication session.

In some examples, the user interaction includes a user request to initiate contact with the agent of the communication session, and the message includes a greeting message that is automatically presented as an initial message in the communication session.

In some examples, the techniques further include: accessing a default prompt for the generating the greeting message; supplementing the default prompt with the subset of information; and generating the greeting message by the generative ML model based on the default prompt that has been supplemented with the subset of information.

In some examples, the first ML model includes a LLM, and the techniques further include: generating an additional prompt for the LLM, the additional prompt requesting relevant user interactions stored in the profile that occurred within a specified time period; and processing the profile based on the additional prompt by the LLM to generate the subset of information and format the subset of information specific to the prompt of the generative ML model.

In some examples, the techniques further include: adding, to the prompt, reservation activity information representing one or more reservations associated with the user corresponding to a specified time period. In some examples, the specified time period corresponds to a most-recently-made reservation.

In some examples, the first ML model determines a current emotion associated with the user based on activity in the profile that occurred within a specified time period prior to a current time. In some examples, the subset of information corresponds to historical user interactions with the listing network platform and behavior data associated with the user.

In some examples, the subset of information includes a name of the user, a destination and check-in information associated with a reservation, content of a conversation between the user and a host of the reservation, and search activity within a help center of the listing network platform. In some examples, the generative ML model is configured to generate messages that dynamically change based on prior user interactions with the listing network platform.

In some examples, the message is a first message generated by the generative ML model. In such cases, the techniques further include: receiving an additional user interaction in response to presenting the first message to the user; and analyzing, by the first ML model, the profile associated with the user on the listing network platform based on the additional user interaction to predict an additional subset of information that is relevant to the user interaction with the communication session. In some examples, the techniques further include: generating a new prompt based on the additional subset of information; and processing the new prompt by the generative ML model to generate a second message that responds to the additional user interaction.

In some examples, the techniques further include, in response to receiving the additional user interaction, presenting the second message by the agent of the listing network platform to the user in a user interface of the listing network platform. In some examples, the techniques further include selecting a default prompt from a plurality of default prompts for combining with the subset of information based on one or more criteria. In some examples, the one or more criteria includes at least one of a time of day, a user interface from which the user interaction is received, a device type being used by the user to perform the user interaction, a quantity of times the user accessed the communication session, a quantity of messages presented to the user by the agent in the communication session, and/or the subset of information.

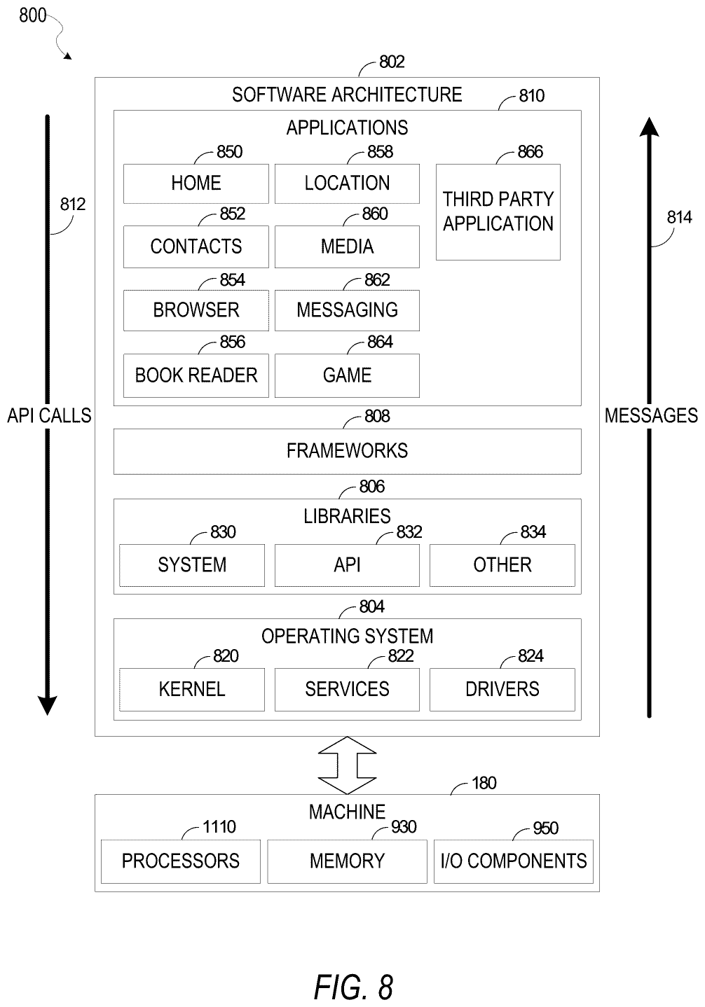

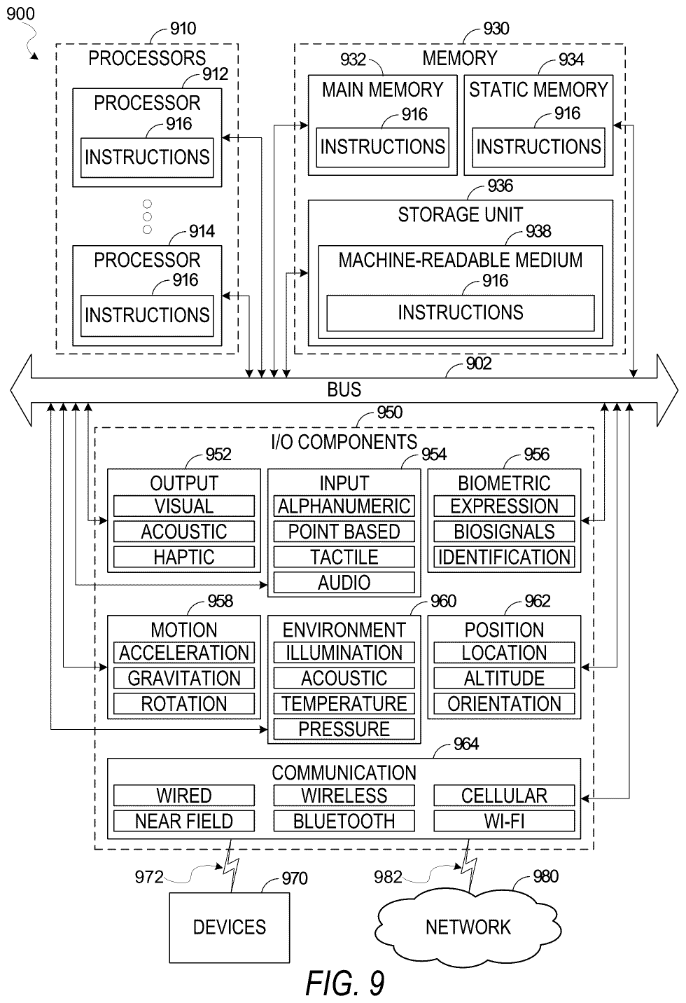

FIG. 8 is a block diagram 800 illustrating an architecture of software 802, which can be installed on any one or more of the devices described above. FIG. 8 is merely a non-limiting example of a software architecture, and it will be appreciated that many other architectures can be implemented to facilitate the functionality described herein. In various examples, the software 802 is implemented by hardware such as a machine 900 of FIG. 9 that includes processors 910, memory 930, and input/output (I/O) components 950. In this example architecture, the software 802 can be conceptualized as a stack of layers where each layer may provide a particular functionality. For example, the software 802 includes layers such as an operating system 804, libraries 806, frameworks 808, and applications 810. Operationally, the applications 810 invoke API calls 812 through the software stack and receive messages 814 in response to the API calls 812, consistent with some examples.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some examples. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some examples. For instance, the drivers 824 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some examples, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some examples. For example, the frameworks 808 provide various GUI functions, high-level resource management, high-level location services, and so forth. The frameworks 808 can provide a broad spectrum of other APIs that can be utilized by the applications 810, some of which may be specific to a particular operating system or platform.

In an example, the applications 810 include a home application 850, a contacts application 852, a browser application 854, a book reader application 856, a location application 858, a media application 860, a messaging application 862, a game application 864, and a broad assortment of other applications such as a third-party application 866. According to some examples, the applications 810 are programs that execute functions defined in the programs. Various programming languages can be employed to create one or more of the applications 810, structured in a variety of manners, such as object-oriented programming languages (e.g., Objective-C, Java, Kotlin, Ruby, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate the functionality described herein.

FIG. 9 illustrates a diagrammatic representation of a machine 900 in the form of a computer system within which a set of instructions may be executed for causing the machine to perform any one or more of the methodologies discussed herein, according to an example. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. The instructions 916 transform the general, non-programmed machine 900 into a particular machine 900 programmed to carry out the described and illustrated functions in the manner described. In alternative examples, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, an STB, a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936, all accessible to the processors 910 such as via the bus 902. The main memory 932, the static memory 934, and storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various examples, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

The various memories (e.g., 930, 932, 934, and/or memory of the processor(s) 910) and/or storage unit 936 may store one or more sets of instructions and data structures (e.g., software) embodying or utilized by any one or more of the methodologies or functions described herein. These instructions (e.g., the instructions 916), when executed by processor(s) 910, cause various operations to implement the disclosed examples.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 980 may be an ad hoc network, an intranet, an extranet, a VPN, an LAN, a WLAN, a WAN, a WWAN, an MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

What is claimed is:

1. A method comprising:
receiving, by a network site, a user interaction in a communication session with an agent of a listing network platform;
analyzing, by a first machine learning model, a profile associated with the user on the listing network platform to predict a subset of information that is relevant to the user interaction with the communication session;
combining the subset of information into a prompt;
processing the prompt by a generative machine learning model to generate a message that responds to the user interaction; and
in response to receiving the user interaction, presenting the message by the agent of the listing network platform to the user in a user interface of the listing network platform.

2. The method of claim 1, wherein the agent comprises a virtual agent, wherein the first machine learning model comprises a first large language model (LLM); and
wherein the generative machine learning model comprises a second LLM.

3. The method of claim 1, wherein the communication session comprises an interactive voice response (IVR) communication session.

4. The method of claim 1, wherein the communication session comprises an online chat communication session.

5. The method of claim 1, wherein the user interaction comprises a user request to initiate contact with the agent of the communication session; and
wherein the message comprises a greeting message that is automatically presented as an initial message in the communication session.

6. The method of claim 5, further comprising:
accessing a default prompt for the generating the greeting message;
supplementing the default prompt with the subset of information; and
generating the greeting message by the generative machine learning model based on the default prompt that has been supplemented with the subset of information.

7. The method of claim 1, wherein the first machine learning model comprises a large language model (LLM), further comprising:
generating an additional prompt for the LLM, the additional prompt requesting relevant user interactions stored in the profile that occurred within a specified time period; and
processing the profile based on the additional prompt by the LLM to generate the subset of information and format the subset of information specific to the prompt of the generative machine learning model.

8. The method of claim 1, further comprising:
adding, to the prompt, reservation activity information representing one or more reservations associated with the user corresponding to a specified time period.

9. The method of claim 8, wherein the specified time period corresponds to a most-recently-made reservation.

10. The method of claim 1, wherein the first machine learning model determines a current emotion associated with the user based on activity in the profile that occurred within a specified time period prior to a current time.

11. The method of claim 1, wherein the subset of information corresponds to historical user interactions with the listing network platform and behavior data associated with the user.

12. The method of claim 11, wherein the subset of information comprises a name of the user, a destination and check-in information associated with a reservation, content of a conversation between the user and a host of the reservation, and search activity within a help center of the listing network platform.

13. The method of claim 1, wherein the generative machine learning model is configured to generate messages that dynamically change based on prior user interactions with the listing network platform.

14. The method of claim 1, wherein the message is a first message generated by the generative machine learning model, further comprising:
receiving an additional user interaction in response to presenting the first message to the user; and
analyzing, by the first machine learning model, the profile associated with the user on the listing network platform based on the additional user interaction to predict an additional subset of information that is relevant to the user interaction with the communication session.

15. The method of claim 14, further comprising:
generating a new prompt based on the additional subset of information; and
processing the new prompt by the generative machine learning model to generate a second message that responds to the additional user interaction.

16. The method of claim 15, further comprising:
in response to receiving the additional user interaction, presenting the second message by the agent of the listing network platform to the user in a user interface of the listing network platform.

17. The method of claim 1, further comprising:
selecting a default prompt from a plurality of default prompts for combining with the subset of information based on one or more criteria.

18. The method of claim 17, wherein the one or more criteria comprises at least one of a time of day, a user interface from which the user interaction is received, a device type being used by the user to perform the user interaction, a quantity of times the user accessed the communication session, a quantity of messages presented to the user by the agent in the communication session, or the subset of information.

19. A system comprising:
one or more processors of a machine; and
a memory storing instruction that, when executed by the one or more processors, cause the machine to perform operations comprising:
receiving, by a network site, a user interaction in a communication session with an agent of a listing network platform;
analyzing, by a first machine learning model, a profile associated with the user on the listing network platform to predict a subset of information that is relevant to the user interaction with the communication session;
combining the subset of information into a prompt;
processing the prompt by a generative machine learning model to generate a message that responds to the user interaction; and
in response to receiving the user interaction, presenting the message by the agent of the listing network platform to the user in a user interface of the listing network platform.

20. A machine-readable storage device embodying instructions that, when executed by a machine, cause the machine to perform operations comprising:
receiving, by a network site, a user interaction in a communication session with an agent of a listing network platform;
analyzing, by a first machine learning model, a profile associated with the user on the listing network platform to predict a subset of information that is relevant to the user interaction with the communication session;
combining the subset of information into a prompt;
processing the prompt by a generative machine learning model to generate a message that responds to the user interaction; and
in response to receiving the user interaction, presenting the message by the agent of the listing network platform to the user in a user interface of the listing network platform.
